(19) United States
(12) Patent Application Publication
(10) Pub. No.: US 2025/0144907 A1
(43) Pub. Date: May 8, 2025

(54) INSPECTION SYSTEM FOR BRAILLE CHARACTERS

(71) Applicant: BOBST MEX SA, Mex (CH)

(72) Inventors: Alexandre DE KALBERMATTEN, Tartegnin (CH); Thomas HOFMANN, Genève (CH)

(73) Assignee: BOBST MEX SA, Mex (CH)

(21) Appl. No.: 18/837,111

(22) PCT Filed: Feb. 10, 2023
(86) PCT No.: PCT/EP2023/053365

§ 371 Date: Aug. 8, 2024

(30) Foreign Application Priority Data
Feb. 14, 2022 (EP) 22156585.6

(51) Int. Cl. B31B 50/00; B31B 50/88

(52) U.S. Cl. CPC B31B 50/006; B31B 50/88

(57) ABSTRACT

The present invention relates to inspection system (46) for checking braille characters in a converting machine (1), the inspection system comprises an image sensor (48) configured to capture at least one image of a first braille tool (36) provided with embossing protrusions (40), a memory (52) and a control unit (51). The control unit is configured to determine an actual braille lettering sequence (Sa) from the at least one image and compare the actual braille lettering sequence to a desired braille lettering sequence stored in the memory.

### FIELD OF THE INVENTION

The present invention relates to a converting machine for producing packaging elements such as folding boxes. In particular, it relates to an inspection system and method for detecting and inspecting braille characters.

### BACKGROUND

Converting machines such as folder-gluers are used in the production of paperboard and cardboard boxes. These machines are fed with blanks and comprise a plurality of workstations which may fold and glue the blanks to form folding boxes. A conditioning section may be arranged at an outlet portion of the converting machine and is configured to stack and condition the blanks in receptacles or in banded stacks.

Some types of boxes need to be provided with braille lettering which enable visually impaired persons to read information. Such types of boxes include pharmaceutical boxes.

Document EP2844462 B1 discloses a converting machine in the form of a folder-gluer machine. The folder-gluer machine is fed with blanks that are already cut to shape and provided with folding lines. Before folding and gluing the blank to form a box, the blank is passed in-between a male braille embossing roller and a female braille embossing roller.

However, the folder-gluer machine produces work batches of different types of boxes in terms of size, paper quality and artwork. Consequently, there is a need to modify the configuration of the braille tools or replace the braille tools in order to match the braille lettering with the artwork and standard printed information on the box.

A plurality of different braille tools is therefore at the disposal of the machine operator. This leads to a risk of confusion between the braille tools for an inexperienced machine operator. Moreover, the braille tools tend to get worn out over time, leading to a negative impact on the quality and readability of the braille pattern transferred onto the blanks.

### SUMMARY

In view of the above-mentioned drawbacks of the prior art, there is a need to further improve the system disclosed in EP2844462 B1 to ensure an accurate transfer and high quality of the braille lettering on the blanks.

According to a first aspect of the present invention there is provided an inspection system for checking braille characters in a converting machine, the inspection system comprising:
an image sensor configured to capture at least one image of a first braille tool provided with embossing protrusions, the first braille tool being provided on a circumference of a first embossing roller,
a memory configured to store a program and a desired braille lettering sequence, and
a control unit configured to execute the program which enables the control unit to retrieve the at least one image from the image sensor, determine an actual braille lettering sequence from the captured at least one image, and to compare the actual braille lettering sequence to the desired braille lettering sequence stored in the memory.

The present invention is based on a realization that the correctness of an embossed braille lettering sequence on a blank can be ensured by capturing at least one image and thus scanning the embossing protrusions on a braille tool. Scanning the braille tool also allows an operator to validate the braille tool before starting the production of boxes. In such a way, the production of a plurality of erroneous boxes can be avoided.

The term “on a circumference” of a first embossing roller means that the first braille tool can either be placed on a portion of the circumference of the embossing roller, or over the entire circumference of the embossing roller. Hence, the expression “on a circumference” is not limited to the first braille tool encircling the entire circumference of the first embossing roller.

The desired braille lettering sequence may be entered into the main control system as an image file. The image file may be entered directly via a machine interface, such as an operator interface comprising a display. Alternatively, the image file can be entered into the main control system from a computing device in a remote location. The computing device may be a computer, laptop, tablet or a smartphone or like. The computing device in the remote location is connected to a machine main control system via a communication network. The communication network may be an Internet network, for instance having a cloud structure.

The converting machine may be a folder-gluer machine. The folder-gluer machine may comprise a braille embossing module provided with cooperating embossing rollers, and wherein the first braille tool is provided on the circumference of an embossing roller.

In an embodiment, the control unit is configured to issue a control signal based on a correspondence between the actual braille lettering sequence and the desired braille lettering sequence.

In an embodiment, the image sensor is further configured to capture images of a second braille tool provided on a circumference of a second embossing roller and provided with embossing cavities. The first and the second braille tools may be provided on the circumference of cooperating embossing rollers.

The program may further comprise instructions enabling the control unit to perform a translation of the actual braille lettering sequence into plain text.

In an embodiment, the control unit is configured to display the translated braille lettering in plain text on a user interface. The user interface may be an operator interface of the converting machine. Additionally, or alternatively, the user interface can be a remote interface in a computer network.

The control unit may be further configured to compare the plain text to a validated master text stored in the memory.

In an embodiment, the image sensor is configured to capture a plurality of images. The control unit can be enabled to retrieve the plurality of images from the image sensor and determine an actual braille lettering sequence from the plurality of captured images.

The program may further comprise instructions for performing a first topographic measurement of the embossing protrusions of the first embossing tool and a second topographic measurement of the embossing cavities of the second embossing tool.

In an embodiment, the inspection system is further configured to capture images of a braille lettering sequence on a blank passing through the converting machine. The inspection device may be configured to measure an embossing depth of the braille lettering sequence formed on the blank.

In an embodiment, the same image sensor is configured to capture images of the first and second braille tools and the embossed braille lettering sequence on the blank.

The image sensor may be rotatably arranged such that it can be rotated and positioned into a plurality of detecting positions. The image sensor may for instance comprise a laser profiler and a camera.

According to a second aspect of the present invention, there is provided a method for inspecting braille characters in a converting machine, the method comprising the steps of:
A) Entering a desired braille lettering sequence into a control system of the converting machine,
B) Activating an image sensor to capture at least one image of a surface of a rotating first braille tool provided with embossing protrusions,
C) Retrieving the at least one image from the image sensor,
D) Determining an actual braille lettering sequence on the first braille tool from the at least one captured image,
E) Comparing and determining a correspondence between the actual braille lettering sequence and the desired braille lettering sequence,
F) Generating a control signal to either start or suspend the converting machine.

The step of determining the actual braille lettering sequence on the first braille tool can be a visual detection of a pattern. Similarly, the step of comparing the correspondence between the actual braille lettering sequence and the desired braille lettering sequence can be a visual comparison performed by a detection of the presence and absence of dots.

In an embodiment, the method further comprises the step of E2) moving the image sensor into a second detecting position and capturing a plurality of images of a second braille tool before step F) is performed.

In an embodiment, the step B is effectuated by the image sensor capturing a plurality of images. The step C is effectuated by retrieving the plurality of images from the image sensor, and step D is effectuated by determining an actual braille lettering sequence from the plurality of images.

In an exemplary embodiment, the method further comprises the steps of:
E2) Calculating the embossing height of the embossing protrusions on the first braille tool and the embossing depth of the embossing cavities on the second braille tool, and
E3) Determining if the embossing height and the embossing depth are within a first and second predefined tolerance ranges, and wherein said steps are performed after step E) and before step F).

### BRIEF DESCRIPTION OF THE DRAWINGS

The invention will now be described with reference to the appended drawings, in which like features are denoted with the same reference numbers and in which:
FIG. 1 is a schematic view of a converting machine in the configuration of a folder gluer;
FIG. 2a is schematic top view of a blank for producing a folding box;
FIG. 2b is a schematic top view of a folding box;
FIG. 3a is a schematic perspective view of a braille embossing module;
FIG. 3b is a schematic perspective detailed view of cooperating braille rollers in the braille embossing module of FIG. 3a;
FIG. 4 is a schematic diagram an inspection system according to an embodiment of the present invention; and
FIGS. 5a to 5c are schematic views of different detecting positions of the present inspection system.

### DETAILED DESCRIPTION

Referring to the figures and in particular to FIGS. 1 and 2a which illustrate a converting machine 1 in the form of a folder-gluer machine 1, and a blank 2 to be processed therein. The folder-gluer machine 1 is configured to receive blanks 2 that are provided with a peripheral edge 4 defining the shape of flaps 6 and which are further provided with crease-lines 8. The crease-lines 8 enable the folding of the blank 2 along pre-defined lines. At the end of the converting machine 1, the blanks 2 have been transformed into of folding boxes 2′.

The present folder-gluer machine 1 comprises a series of different workstations in the form of modules. The modules may include, from an inlet to an outlet: a feeder module 10, a braille embossing module 11, a fold pre-breaking module 12, a gluing module 14 and a folding module 16. After the gluing and folding modules 14, 16, a delivery module and conditioning section 20 can be provided in order to count and separate a shingled stream of folding boxes 2′ into separate batches and to arrange them together in receptacles or banded stacks. The converting machine 1 may also comprise an optional module such as a quality control device 18 for checking the surface of the blank 2. The converting machine 1 further comprises a conveyance system comprising conveyors such as endless belts in order to transport the blank 2 in a direction of conveyance D.

As illustrated in FIGS. 3a and 3b, the braille embossing module 11 comprises a first braille embossing roller 30 and a second braille embossing roller 32 which are mounted such as to receive the blank 2 in a clearance c between them.

The braille embossing rollers 30, 32 may comprise mounting means 34 for a first braille tool 36 and a second braille tool 38, respectively. The first and second braille tools 36, 38 are mounted on the circumference of the first and second embossing rollers 30, 32, respectively. The first and second braille tools 36, 38 are preferably in the form of flexible metal plates.

The first braille tool 36 is mounted vertically above the second braille tool 38 and preferably comprises protrusions 40 on its outer surface. The second braille tool 38 is provided with corresponding cavities 42 on its outer surface. The cavities 42 are configured to receive the protrusions 40 when the embossing rollers 30, 32 are rotated. The first braille tool 36 is provided with a braille lettering sequence S. The second braille tool 38 may be a standard tool which is provided with cavities 42 configured to receive any braille protrusion 40 irrespective of its location. Within the context of this application, the first braille tool 36 may be referred to as a “male braille tool” and the second braille tool 38 may be referred to as a “female braille tool”.

As illustrated in FIG. 4, an inspection system 46 is provided in the proximity of the braille embossing module 11. The inspection system 46 comprises an image detector 48 configured to capture images of the first braille tool 36. The image detector 48 comprises an illumination device 49 and a camera 50. The illumination device 49 illuminates the relief of the first braille tool 36 while the camera 50 captures at least one image. Preferably, the camera 50 is configured to capture a plurality of images of the first braille tool 36. The camera 50 may comprise an area scan camera and the illumination device 49 may be a laser profiler. The area scan camera is configured to capture two-dimensional images of the first braille tool 36.

In order to capture a complete image of the full braille lettering sequence S on the first braille tool 36, the image detector 48 is preferably capturing a plurality of images while the first braille tool 36 is rotated. The first braille tool 36 may be rotated one full revolution (i.e. 360°), or to an angular displacement over which the first braille tool 36 is mounted.

The inspection system 46 further comprises a control unit 51 and a memory 52. The memory 52 may comprise a program including an algorithm which enables the control unit 51 to extract two-dimensional images from the image sensor 48. The memory 52 is further configured to store a desired braille lettering sequence Sv. The desired braille lettering sequence Sv is preferably a pattern. The desired braille lettering sequence Sv can be a graphical representation such as dot plot or an image. The pattern may be stored as an image file. The desired braille lettering sequence Sv may be entered into the memory 52 together with a job configuration file.

The job configuration file may contain a plurality of settings required to produce a specific work batch of folding boxes 2′. The job configuration file may contain spatial coordinates of the desired braille lettering sequence Sv on the blank 2. The location of the desired braille lettering sequence Sv on the blank 2 enables the control unit 51 to determine and calibrate the field of view F of the camera 50. Additionally, the job configuration file may comprise details of the size of the braille pattern, ejection thresholds, and a measurement sequence for the inspection system 46. The ejection threshold may be one or a plurality of non-acceptable deviations from desired positions such as displacements of distances etc. It is particularly useful to define ejection thresholds if the converting machine 1 is equipped with an ejection module for erroneous blanks.

The job configuration file can be entered into a main control system 54 of the converting machine 1. This means that a new desired braille lettering sequence Sv can be automatically entered into the memory 52 of the inspection system 46 each time a new job configuration file is uploaded. However, the job configuration file may be stored in the memory 52 and can be retrieved therefrom for a repeated work batch of similar folding boxes 2′.

Additionally, or alternatively, the job configuration file or at least some configuration parameters including the desired braille lettering sequence Sv can be stored on a remote server 56. The remote server 56 and the main control system 54 are connected in a computer network. The network may comprise an Internet connection between the main control system 54 of the converting machine 1 and the remote server 56 The remote server 56 may be located in a cloud-based network. In such a way, the job configuration file or at least some configuration parameters can be transmitted from the remote server 56 to the control unit 51 of the inspection system 46. The converting machine 1 can thus be automatically set from a remote location in a computer network.

However, if the job configuration file does not contain a desired braille sequence Sv, the main control system 54 may deactivate the inspection system 46. This is useful for converting machines 1 which also produce folding boxes 2′ without braille lettering.

The program in the memory 52 further enables the control unit 51 to perform a control procedure for checking the first braille tool 36. The procedure allows a validation of the first braille tool 36 in relation to the job configuration file for the folding boxes 2′. The program is configured to activate the image detector 48. The control unit 51 is configured to receive at least one image from the image detector 48. Preferably, the control unit 51 is configured to receive a plurality of captured images from the image detector 48 and to generate a composed three-dimensional image from the plurality of images. The three-dimensional image is then entered into the memory 52. Preferably, the control unit 51 is configured to only extract the dot height and dot position from the captured images. The control unit 51 may thus be configured to perform a topographic measurement of the braille protrusions 40 on the first braille tool 36. The dot height and dot position can be illustrated in a composed three-dimensional image, which is a topographical image.

The program further enables the control unit 51 to determine an actual braille lettering sequence Sa from the topographic image. The actual braille lettering sequence Sa can be a graphical representation such as dot plot or an image containing the locations of the braille dots. Hence, the actual braille lettering sequence Sa is preferably represented in braille dots, and not in a standard visually readable printed text.

The program enables the control unit 51 to determine an actual braille lettering sequence Sa from the at least one image. The program preferably also comprises instructions enabling the control unit 51 to compare the actual braille lettering sequence Sa to the desired braille lettering sequence Sv stored in the memory 52.

The control unit 51 may issue a control signal based on a correspondence between the actual braille lettering sequence Sa and the desired braille lettering sequence Sv. The control signal may either suspend or enable the converting machine 1. If the determined actual braille lettering sequence Sa does not match the desired braille lettering sequence Sv in the memory 52, the control unit 51 may issue an error signal. The error signal may suspend the operation of the converting machine 1. In such a way, the control unit 51 may provide information to the main control system 54 that the first braille tool 36 is not right for the job. The threshold of determining an error state can be set to the absence of one dot or the presence of one erroneous dot.

Additionally, the program may contain instructions enabling the control unit 51 to perform a translation of the actual braille lettering sequence Sa into plain text. The translated text may be displayed on an operator interface 55 of the converting machine 1. This provides an advantage of further allowing an operator, incapable of reading braille lettering, to easily understand if the first braille tool 36 carries a wrong braille lettering sequence S which does not match with the standard printed text on the blank 2. Additionally or alternatively, the translated text may be displayed on a remote interface 57 in a computer network.

The inspection system 46 may be further configured to determine the surface quality of the first and second braille tools 36, 38. The first and second braille tools 36, 38 are subject to wear, and it is advantageous to monitor their surface quality. As the embossing protrusions 40 are received in aligned cavities 42, any displacement in the synchronization of the tools 36, 38 may cause mechanical wear between the tools 36, 38. When the quality of the first and second braille tools 36, 38 is continuously monitored, the problem of excessive wear due to mis-synchronization can be detected early before the tools 36, 38 are worn out to a point that they are unusable.

The control unit 51 may determine an expected remaining production time for the first and second braille tools 36, 38 from the determined surface quality. In such a way, the replacement of the braille tools 36, 38 can be anticipated. The remaining production time can for instance be defined in terms of a quantity of folding boxes 2′ with braille lettering. Alternatively, the remaining production time can be defined in remaining revolutions of the braille tools 36, 38 (i.e., a 360-degree rotation of the respective braille embossing roller 30, 32). A calculation of the expected remaining production time may be performed at the start-up of the folder-gluer 1. This may ensure that the surface quality of braille tools 36, 38 will at least be sufficient for the number of boxes 2′ in the planned work batch (i.e., production run).

It may also be possible to provide the individual braille tools 36, 38 with an identification element 39. The identification element 39 may for instance be an RFID tag, a barcode or QR code or a numeric reference engraved or printed onto the braille tools 36, 38. In such a way, the control unit 51 may log the lapsed usage time for each braille tool 36, 38 and predict the remaining usage time. The lapsed usage time and remaining usage time may be uploaded in a central monitoring system surveilling overall machine health and performance. The central monitoring system may be located on the remote server 56.

The height of each protrusion 40 may be determined and compared to a predetermined first tolerance range Tr1. The first tolerance range Tr1 ranges between a lowest acceptable braille protrusion height T1 min and a highest acceptable braille protrusion height T1 max. The first tolerance range Tr1 may for instance be a deviation of about +/−0.05 mm from a desired protrusion height T1. The first tolerance range Tr1 may be identical for each embossing protrusion 40.

Alternatively, depending on the specific location of a dot, the tolerance range Tr1 may be different. Additionally, a topographic measurement may be performed on the braille cavities 42 of the second braille tool 38. The depth of each cavity 42 may be determined and compared to a predetermined second tolerance range Tr2. The second tolerance range Tr2 ranges between a lowest acceptable braille cavity depth T2 min and a highest acceptable braille cavity depth T2 max.

The control unit 51 may issue an error signal when either an embossing protrusion 40 or an embossing cavity 42 is outside of each respective tolerance range Tr1, Tr2. This enables the control unit 51 to determine if the surface quality of the braille tools 36, 38 is sufficient to produce boxes 2′ having a braille lettering sequence S with an acceptable quality.

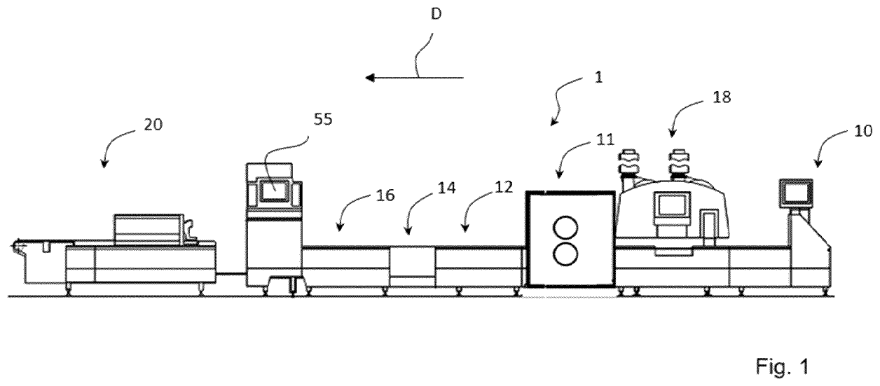

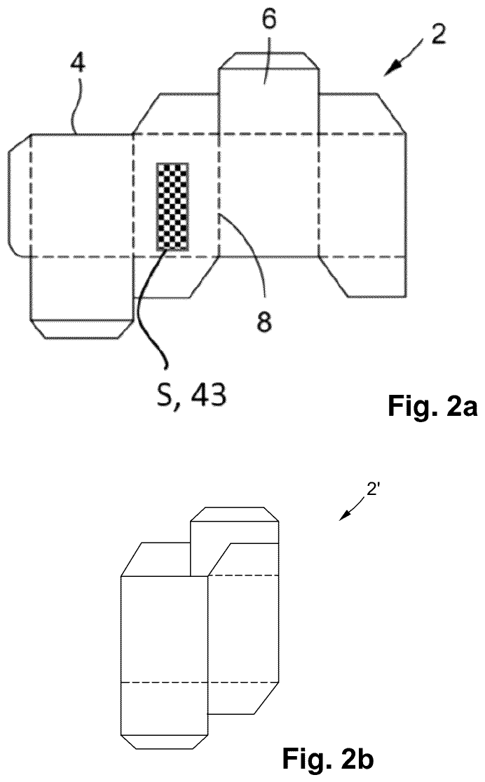

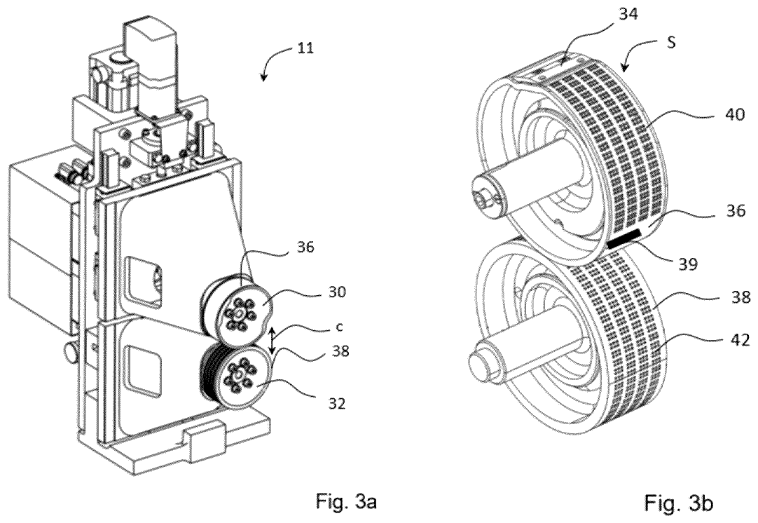

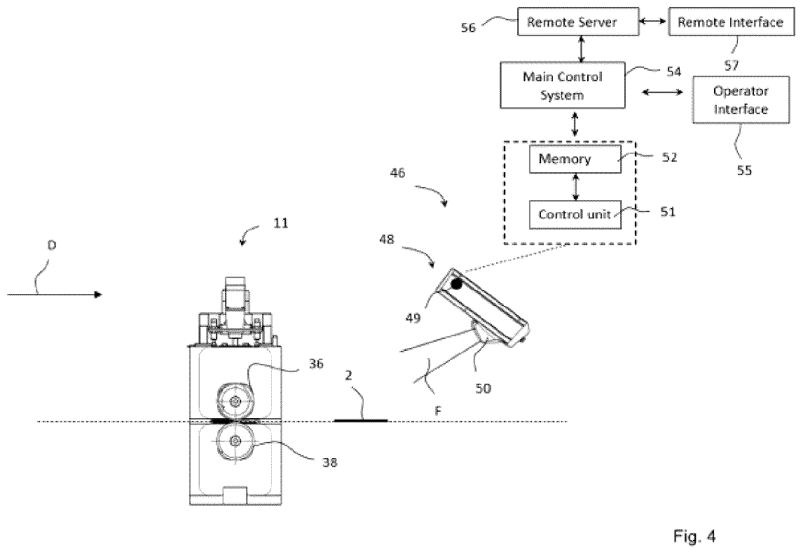

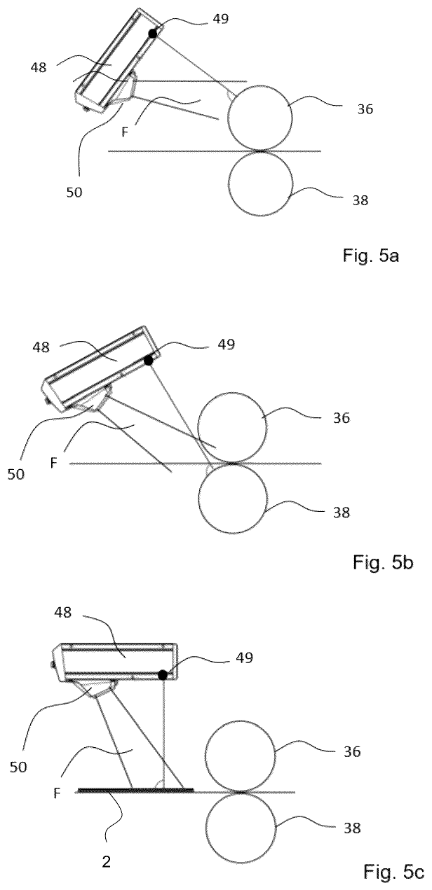

The image sensor 48 is preferably positioned downstream of the braille embossing module 11 in the direction of conveyance D. The image sensor 48 may be positioned in a location where both the first braille tool 36 and the second braille tool 38 are in the field of view F of the camera 50. However, in a preferred embodiment and as illustrated in FIGS. 5a to 5c, the image sensor 48 can be configured with a modifiable field of view F. In such a way, the image sensor 48 is in a first position when capturing images of the first braille tool 36, and in a second position when capturing images of the second braille tool 38.

This may be achieved by configuring the image sensor 48 to be rotatably arranged. In such a way, the image sensor 48 can be rotated into a plurality of detecting positions. In a first detecting position and as illustrated in FIG. 5a, the field of view F may be aligned with the first braille tool 36. In a second detecting position and as illustrated in FIG. 5b, the field of view F may be aligned with the second braille tool 38.

Additionally, as illustrated in FIG. 5c, the image sensor 48 may be further configured to pivot into a third detecting position, in which the field of view of the camera 50 is aligned with the position of the embossed braille lettering sequence S on the blank 2. The embossed cavities on each blank 2 can be detected and their depth can be measured. In such a way, a final quality control can be performed on each blank 2. This is advantageous, as it will detect any quality errors due to the blank substrate (for instance caused by the quality and thickness of the paper, the hygrometry, etc.) and in combination with the male and female braille tools 36, 38. Additionally, and in the case of non-reoccurring errors, erroneous blanks 2 may be ejected in a downstream-located ejector module.

The final quality control may also include a measurement of the position of the actual braille lettering sequence Sa on the blank 2. An error message may be generated to if an erroneous position is determined. The error message may be visually indicated on the operator interface 55 of the converting machine or on a remote interface 57. Additionally, or alternatively, the error message can be an audible signal. Erroneous blanks 2 can be ejected with an ejection module (such as the one described in document EP2976279) if the actual braille lettering sequence Sa is not in the correct position on the blank 2. The correct position may be defined by a predetermined longitudinal coordinate with reference to the leading edge of the blank 2 in the direction of conveyance D. Optionally the correct position may also be further defined from a lateral edge of the blank 2.

The control unit 51 may thus be configured to determine the actual position of the actual braille lettering sequence Sa on the blank 2 and to calculate a deviation from the predefined longitudinal coordinate. The predefined longitudinal coordinate can be defined from the leading edge of the blank 2 in the direction of conveyance D.

In an embodiment, an inspection sequence can be performed by first inspecting the second braille tool 38 provided with cavities 42. This allows the control unit 51 to first acquire information where it is possible to receive a braille protrusion 40. The control unit 51 can give a warning signal or suspend the operation of the converting machine if there are obstructed cavities 42.

Alternatively, the inspection sequence can be performed by first inspecting the first braille tool 36 provided with embossing protrusions 40, then the second braille tool and at last the blank 2.

When using the present inspection system 46, a desired braille lettering sequence Sv is first entered into a main control system 54 of the converting machine 1. The desired braille lettering sequence Sv may be entered into the main control system 54 as an image file. The image file may for instance be a pdf file or a standard image file such as jpeg or gif. The image file may contain other visual information such as a motif and ink-printed lettering fields. The image file may also further contain the dimensions of the blank, including positions of flaps and crease lines.

A reference position for the visual information and the crease-lines may for instance be a lateral edge or a front edge of the blank 2, or both.

The image file may be entered directly via the operator interface 55. Alternatively, the image file can be entered into the main control system 54 from a remote location which is connected to the main control system 54 via a communication network, such as an Internet network. The communication network may have a cloud structure.

The step of determining the actual braille lettering sequence Sa on the first braille tool 36 can be a visual detection of a pattern. Similarly, the step of comparing the correspondence between the actual braille lettering sequence Sa and the desired braille lettering sequence Sv can be a visual comparison detecting the presence and absence of dots.

The main control system 54 may be a centralized control system in which also other parameters, such as artwork, box dimensions, production speed etc. are entered. The desired braille lettering sequence Sv may be received in the inspection system via an Internet connection from the remote server 56. Alternatively, the desired braille lettering sequence Sv may be uploaded into the memory 52 of the inspection system 46 via a communication port. However, it may still be possible to manually enter some data related to the braille lettering into the main control system 54. For instance, entering or modifying the desired threshold values T1r, T2r in terms of dot height or cavity depth.

The image sensor 48 is then activated to capture at least one image of the surface of the first braille tool 36. Preferably, the image sensor 48 captures a plurality of images of the surface of the first braille tool 36 provided with the embossing protrusions. This scanning procedure is preferably carried out while rotating the first braille tool 36. The control unit 51 retrieves the plurality of images from the image sensor 48. The number of captured images correspond to a required resolution. The control unit 51 may then assemble the plurality of captured images into a composed three-dimensional image. A typical resolution of the scanned images may be around 1000 pixels wide. The control unit 51 may then determine an actual braille lettering sequence Sa on the first braille tool 36 from the at least one or the plurality of scanned images. The actual braille lettering sequence Sa is then compared to the desired braille lettering sequence Sv. Based on the comparison, the control unit 51 may determine a correspondence between the actual braille lettering sequence Sa and the desired braille lettering sequence Sv.

A control signal may further be generated based on the correspondence. The control signal may be a binary signal. The control signal may either authorize the start of the converting machine 1 or suspend operation of the converting machine 1. Additionally, or alternatively, the control signal may generate a message on an operator interface 55 of the converting machine. Additionally, or alternatively, the message can be generated on a remote interface 57 in a computer network.

This procedure allows the inspection system 46 to detect if the actual braille lettering sequence Sa on the first braille tool 36 is correct. In an advantageous embodiment, the method further comprising the steps of measuring the embossing height of the embossing protrusions 40 on the first braille tool 36 and the embossing depth of the embossing cavities 42 on the second braille tool. The measurement can be performed from the composed three-dimensional image, as previously described.

The control unit 51 may then further determine if the embossing height and the embossing depth are within a first and second predefined tolerance ranges Tr1,Tr2. The first tolerance range Tr1 s provided for the first braille tool 36, and a second tolerance range Tr2 is provided for the second braille tool 38. The tolerance range Tr1 for the first braille tool 36 may be narrower than the tolerance range Tr2 for the second braille tool 38. The control unit 51 may therefore further check that the height of the embossing protrusions and the depth of the embossing cavities are within the respective tolerance range Tr1, Tr2 before issuing a control signal.

1. An inspection system for checking braille characters in a converting machine, the inspection system comprising:
an image sensor configured to capture at least one image of a first braille tool provided with embossing protrusions, the first braille tool being provided on a circumference of a first embossing roller,
a memory configured to store a program and a desired braille lettering sequence, and
control unit configured to execute the program which enables the control unit to retrieve the at least one image from the image sensor, determine an actual braille lettering sequence from the at least one image, and to compare the actual braille lettering sequence to the desired braille lettering sequence stored in the memory.

2. The inspection system according to claim 1, wherein the control unit is configured to issue a control signal based on a correspondence between the actual braille lettering sequence and the desired braille lettering sequence.

3. The inspection system according to claim 1, wherein the image sensor is further configured to capture images of a second braille tool provided on a circumference of a second embossing roller and provided with embossing cavities.

4. The inspection system according to claim 3, wherein the first braille tool and the second braille tool are respectively provided on the circumferences of cooperating embossing rollers.

5. The inspection system according to claim 1, wherein the program further comprises instructions enabling the control unit to perform a translation of the actual braille lettering into plain text.

6. The inspection system according to claim 5, wherein the control unit is configured to display the translated braille lettering in plain text on a user interface.

7. The inspection system according to claim 5, wherein the control unit is configured to compare the plain text to a validated master text stored in the memory.

8. The inspection system according to claim 3, wherein the image sensor is configured to capture a plurality of images, and wherein the control unit is enabled to retrieve the plurality of images from the image sensor and determine an actual braille lettering sequence from the plurality of images.

9. The inspection system according to claim 8, wherein the program further comprises instructions for performing a first topographic measurement of the embossing protrusions of the first embossing roller and a second topographic measurement of the embossing cavities of the second embossing roller.

10. The inspection system according to claim 3, wherein the inspection system is further configured to capture images of a braille lettering sequence on a blank passing through the converting machine.

11. The inspection system according to claim 10, wherein the inspection system is configured to measure an embossing depth of the braille lettering sequence formed on the blank.

12. The inspection system according to claim 10, wherein the same image sensor is configured to capture images of the first braille tool and the second braille tool and the embossed braille lettering sequence on the blank.

13. The inspection system according to claim 11, wherein the image sensor is rotatably arranged such that the image sensor can be rotated and positioned into a plurality of detecting positions.

14. The inspection system according to claim 1, wherein the image sensor comprises a laser profiler and a camera.

15. A method for inspecting braille characters in a converting machine, the method comprising:
A) Entering a desired braille lettering sequence into a main control system of the converting machine,
B) Activating an image sensor to capture at least one image of a surface of a rotating first braille tool provided with embossing protrusions,
C) Retrieving the at least one image from the image sensor,
D) Determining an actual braille lettering sequence on the rotating first braille tool from the at least one image,
E) Comparing and determining a correspondence between the actual braille lettering sequence and the desired braille lettering sequence, and
F) Generating a control signal to either start or suspend the converting machine.

16. The method according to claim 15, further comprising E2) moving the image sensor into a second detecting position and capturing a plurality of images of a second braille tool before step F) is performed.

17. The method according to claim 15, wherein the image sensor captures a plurality of images, the plurality of images is retrieved from the image sensor and an actual braille lettering sequence is determined from the plurality of images.

18. The method according to claim 16, further comprising:
E2) Calculating the embossing height of the embossing protrusions on the first braille tool and the embossing depth of the embossing cavities on the second braille tool, and
E3) Determining if the embossing height and the embossing depth are within a first and second predefined tolerance ranges, and wherein step E2) and step E3) are performed after step E) and before step F).
